(19) United States
(12) Patent Application Publication
(10) Pub. No.: US 2003/0024934 A1
(43) Pub. Date: Feb. 6, 2003

(54) Foam insulated fuel tank

(76) Inventor: Marshall R. Moore, Tampa, FL (US)

Correspondence Address: SMITH & HOPEN PA, 15950 BAY VISTA DRIVE, SUITE 220, CLEARWATER, FL, 33760

(21) Appl. No.: 09/682,168

(22) Filed: Jul. 31, 2001

(51) Int. Cl. F17C 1/00; F17C 3/00; F17C 13/00

(52) U.S. Cl. 220/560.03

(57) ABSTRACT

A relatively lightweight generator base tank for storing flammable and combustible liquids comprising an inner primary tank encased by foam and fire resistant material which is further encased by an outer secondary tank. The system results in a storage tank that is less likely to leak hazardous substances to the environment and is protected from fire and physical damage.

### BACKGROUND OF INVENTION

1. Field of Invention

This invention relates to fuel tanks, and more particularly to a relatively lightweight structure for containing fuel that protects against fuel leakage and has fire protection qualities.

2. Background of the Invention

Large generators are self contained sources of power that run on liquid fuel to provide auxiliary power. The tank that provides a reservoir of fuel for the motor is an integral part of the generator. Generators are required to provide uninterrupted power for extended periods of time without refueling.

The footprint of the generator is sometimes limited by the space available on site. In the past, fuel tanks for generators have been typically located below ground. This allows for less space used for a generator installation. Having a fuel tank underground also provides protection for the environment and persons from accidental ignition and explosion of the fuel. However, current practices utilize above ground fuel tanks with the generator resting atop the fuel tank. This accommodates the requirements of a reduced footprint for the generator installation and lessens the risk of undetected contamination of the environment. Furthermore, the Underground Storage Tank (UST) regulations that EPA published in the Federal Register on Sep. 23, 1988 established a number of requirements for UST owners and operators, which include release response and corrective action for UST systems. The number of UST sites requiring corrective action has increased and by September 2000 states reported over 412,000 confirmed releases of hazardous substances into the environment by USTs.

Aboveground storage tanks are being used more frequently to address the problems of environmental contamination from leaking underground storage tanks. The aboveground fuel tanks are shop fabricated, inspected and tested for leakage prior to installation. Aboveground storage tanks designated as “generator base tanks” are designed to serve as a support means and base for a generator. Generator base tanks are built with a dual tank configuration where an inner primary tank is encased by an outer integral secondary tank. The dual tank construction is intended to limit the heat transferred to the primary tank and also to prevent any leakage from the primary tank from entering the environment. Underwriters Laboratory Inc. (UL) standard 2085 is associated with the safety for protected aboveground tanks for flammable and combustible liquids. UL 2085 provides the requirements that cover shop fabricated, aboveground atmospheric protected tanks intended for the storage of stable, flammable, or combustible liquids that have a specific gravity not greater than 1.0 and that are compatible with the material and construction of the tank. Tank constructions that meet UL 2085 will limit the heat transferred to the primary tank when exposed to a two-hour hydrocarbon pool fire and provide protection from physical damage.

Concrete between the inner primary tank and the outer secondary tank provides fire protection for the stored fuels. By way of example, U.S. Pat. Nos. 5,695,089 and 5,809,650 to Reese et al. use porous concrete as an insulator. The concrete works well as a fire shield, however, the concrete also makes the tank extremely heavy and cumbersome to transport and install.

U.S. Pat. No. 3,875,886 to Glasfeld et al. describes an insulating layer comprising foamed plastic material in combination with a thin, solid barrier layer or liner applied thereto. However, the Glasfeld patent is directed to cryogenic fluid storage and accordingly addresses problems of extreme cold and ductility in conventional steel tanks. Conversely, the instant invention relates more specifically to fire hazards.

U.S. Pat. No. 3,787,279 to Winchester describes a fuel tank for military aircraft to minimize the damage caused by enemy gunfire. More particularly, the Winchester patent seeks to reduce pressure pulses caused by the penetration of 0.50 caliber and larger projectiles in liquid fuel tanks. Winchester does not disclose the use of a Kevlar or Mylar flame shield.

U.S. Pat. No. 5,087,513 to Kim describes a flame retardant composite which may be woven into fabrics such as Kevlar, polyester or nylon for use as the first layer of a two layer composite. However, the Kim patent is chemical in nature and does not suggest application of its particular chemical composition to a fuel tank application.

U.S. Pat. No. 5,285,920 to McGarvey describes an above-ground fire resistant tank having a thermal barrier which may be injected with foam. However, McGarvey does not suggest the use of Kevlar or Mylar but suggests a hydrate aluminum-iron magnesium silicate to be used in conjunction with Portland cement.

U.S. Pat. No. 5,601,204 to Hall describes an above-ground fuel storage tank having an inner space between an interior tank wall and an outer tank wall fillable with insulating material. However, the Hall patent does not describe or suggest the application of a thin fireproof laminate to an insulating layer. Hall specifically recommends the use of concrete as the insulating material, thereby producing a heavy structure.

U.S. Pat. No. 5,833,782 to Crane et al. describes an internal explosion containment enclosure substantially defined as a sandwich-like arrangement of two fiber-reinforced matrix skins and a foam core disposed therebetween. However, Crane patent teaches the application of the foam barrier for application to explosive containment and not fuel storage.

U.S. Pat. No. 5,924,134 to Taylor et al. describes a protective garment with a foam liner sandwiched by Mylar layers to produce a fire-retardant composite. It should be noted that this patent is specifically directed to a garment and does not suggest the application of this barrier layer to above-ground fuel storage systems.

Accordingly, what is needed in the art is a fire resistant fuel tank which meets all applicable fire requirement standards and is concomitantly relatively lightweight and is easy to install. It is, therefore, to the effective resolution of the aforementioned problems and shortcomings of the prior art that the present invention is directed.

However, in view of the prior art in at the time the present invention was made, it was not obvious to those of ordinary skill in the pertinent art how the identified needs could be fulfilled.

### SUMMARY OF INVENTION

The present invention is an aboveground storage tank for flammable and combustible liquids having secondary containment capability, comprising an inner primary tank for storing the liquid, an outer secondary tank encasing the inner primary tank defining a substantially uniform interstitial space therebetween, an insulating foam material disposed of in the substantially uniform interstitial space, and a fire resistant textile material sandwiched between the foam material and the outer secondary tank so that a fire resistant composite comprised of insulating foam and fire resistant textile material encases the inner primary tank.

The insulating foam material located in the interstitial area between the primary inner tank and the secondary outer tank can be polystyrene, urethanes, polymethyl methacrylate, or a variety of other polymers. For most embodiments and applications of the present invention, the foam material is preferably a synthetic polymer or rubber. The fire resistant textile material can be a high-temperature polyester film material such as Mylar or Kevlar.

It is therefore an object of the present invention to provide a relatively lightweight generator base tank.

It is another object of the present invention to provide a generator base tank that meets or exceeds all applicable fire resistant standards.

It is to be understood that both the foregoing general description and the following detailed description are explanatory and are not restrictive of the invention as claimed. The accompanying drawings, which are incorporated in and constitute part of the specification, illustrate embodiments of the present invention and together with the general description, serve to explain principles of the present invention.

These and other important objects, advantages, and features of the invention will become clear as this description proceeds.

The invention accordingly comprises the features of construction, combination of elements, and arrangement of parts that will be exemplified in the description set forth hereinafter and the scope of the invention will be indicated in the claims.

### BRIEF DESCRIPTION OF DRAWINGS

For a fuller understanding of the nature and objects of the invention, reference should be made to the following detailed description, taken in connection with the accompanying drawings, in which:

FIG. 1 is a side elevation view of the tank;

FIG. 2 is an end elevation view of the tank;

FIG. 3 is a partial enlarged sectional view of the tank side wall;

FIG. 4 is a side elevation view of the tank with a generator housing installed on top of the tank; and

FIG. 5 is a top view of the tank and generator housing.

### DETAILED DESCRIPTION

FIG. 1 shows the side elevation view of the tank 10. The double wall tank includes an inner primary tank wall 20 and an outer secondary tank wall 30. Fuel stored in the tank is contained in the inner tank volume denoted as 120. Generator vibration isolators 70 are shown for reference to the generator attachment means. Isolators 70 prevent excessive movement by the generator from being transferred to the fuel in the tank 10 and thus reduce the vapor pressure buildup in inner tank volume 120.

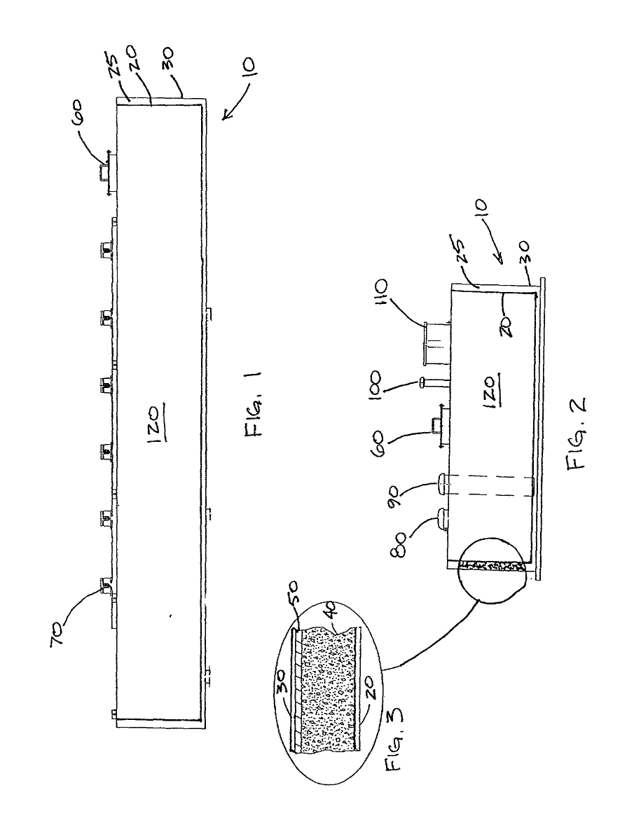

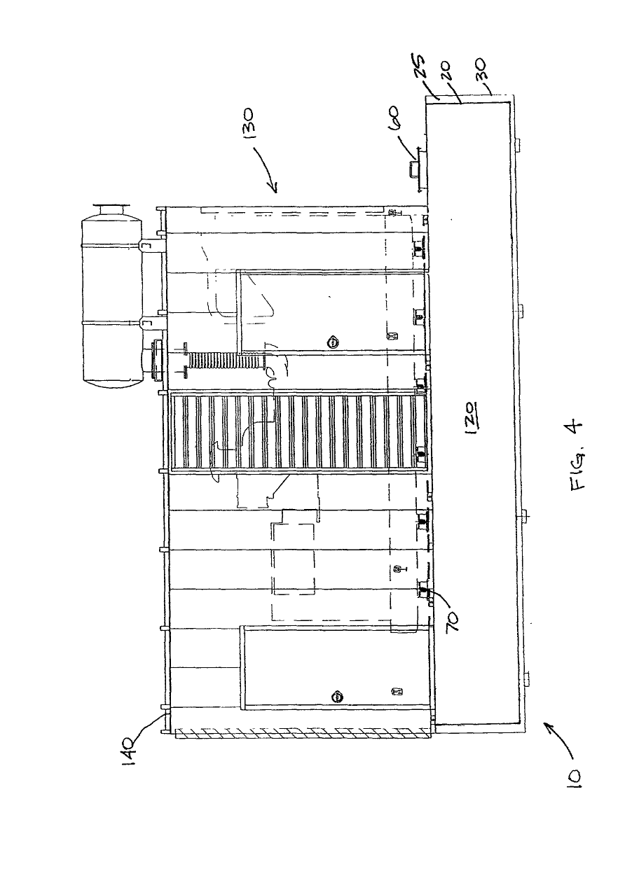

A secondary emergency vent 90 provides an escape for vapor pressure buildup in interstitial space 25 between primary tank wall 20 and secondary tank wall 30 as shown in FIG. 2. A primary emergency vent 80 provides a release for extreme vapor pressure buildup in inner tank volume 120. Manhole 60 is provided to allow inspection of inner tank volume 120 and associated monitoring equipment located inside primary tank 120. Gauge 100 monitors the fuel level in the inner primary tank 120 and fuel inlet 110 functions as a means to pour liquid into the inner primary tank 120.

FIG. 3 shows the double wall construction of the present invention in which the interstitial space 25 is filled with insulating material 40 and encased by the outer secondary tank wall 30 and the inner primary tank wall 20. In the preferred embodiment the insulating material 40 is a foam material comprised of synthetic polymer such as polystyrene, urethanes, or polymethyl methacrylate. Fire resistant textile material 50 that is sandwiched between the foam material and the outer secondary tank provides additional fire protection from leakage or penetration of the secondary tank 30. The fire resistant textile material 50 in the preferred embodiment is a high-temperature polyester film material such as Mylar or Kevlar.

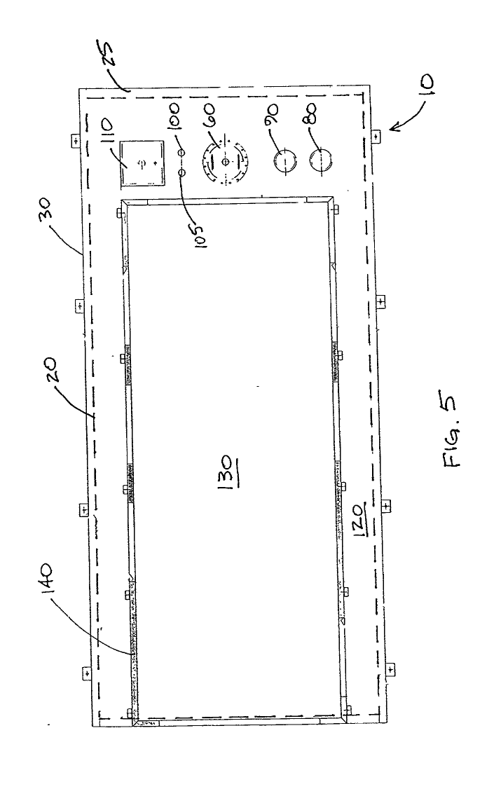

FIG. 4 shows the present invention with a generator and generator housing 140 generally denoted in combination as 130 attached to the top portion of the fuel tank 10. FIG. 5 shows a top view of the tank 10 and generator housing 130. A screened atmospheric vent 105 prevents excessive pressure from building up inside primary tank 120.

The walls of the double wall tank are made of carbon steel as specified in UL 142 and welded together by conventional techniques well known in the art. In the preferred embodiment, the inner tank is constructed of ¼ inch A-36 hot rolled carbon steel plate and the outer secondary tank is constructed of 5/16 inch A-36 hot rolled carbon steel plate. The inner tank volume 120 has a nominal capacity of 5500 gallons. The weight of the tank without fuel is approximately 12,500 pounds. the dimensions of the tank are approximately 24 feet in length, 11 feet in width and 3.3 feet in height.

It will be seen that the objects set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Now that the invention has been described,

1. An aboveground storage tank for flammable and combustible liquids having secondary containment capability, comprising:
an inner primary tank for storing the liquid;
an outer secondary tank encasing the inner primary tank defining a substantially uniform interstitial space therebetween;
an insulating foam material disposed of in the substantially uniform interstitial space; and
a fire resistant textile material sandwiched between the foam material and the outer secondary tank so that a fire resistant composite comprised of insulating foam and fire resistant textile material encases the inner primary tank.

2. The storage tank of claim 1 in which the inner primary tank is A-36 hot rolled carbon steel.

3. The storage tank of claim 1 in which the outer secondary tank is A-36 hot rolled carbon steel.

4. The storage tank of claim 1 wherein the fire resistant textile material is Mylar.

5. The storage tank of claim 1 wherein the fire resistant textile material is Kevlar.

6. The storage tank of claim 1 wherein the insulating foam material is polystyrene.

7. The storage tank of claim 1 wherein the insulating foam material is a urethane polymer.

8. The storage tank of claim 1 wherein the insulating material is polymethyl.

9. The storage tank of claim 1 wherein the insulating material is a synthetic polymer.

10. The storage tank of claim 1 wherein the insulating material is rubber.

11. The storage tank of claim 1 further comprising an interstitial leak sensor for monitoring leakage of the inner primary tank.

12. The storage tank of claim 1 further comprising a first venting means for venting the inner primary tank.

13. The storage tank of claim 1 further comprising a second venting means for venting the interstitial space containing the fire resistant composite.

14. The storage tank of claim 1 in which the tank is used as a fuel storage tank to provide fuel for a generator.

15. The storage tank of claim 1 further comprising a support means to form a base for a generator apparatus so that the generator apparatus is supported by the top surface of the fuel storage tank thereby reducing the space required for the generator apparatus.

16. An aboveground storage tank for flammable and combustible liquids having secondary containment capability, comprising:
an inner primary tank for storing the liquid wherein the inner primary tank is A-36 hot rolled carbon steel;
an outer secondary tank encasing the inner primary tank defining a substantially uniform interstitial space therebetween wherein the secondary tank is A-36 hot rolled carbon steel;
an insulating foam material disposed of in the substantially uniform interstitial space wherein the foam material is a synthetic polymer;
a fire resistant textile material sandwiched between the foam material and the outer secondary tank so that a fire resistant composite comprised of insulating foam and fire resistant textile material encases the inner primary tank wherein the fire resistant textile material is Kevlar;
an interstitial leak sensor for monitoring leakage of the inner primary tank;
a first venting means for venting the inner primary tank;
a second venting means for venting the interstitial space containing the fire resistant composite; and
a support means to form a base for a generator apparatus so that the generator apparatus is supported by the top surface of the fuel storage tank thereby reducing the space required for the generator apparatus.
